(19) United States
(12) Patent Application Publication
(10) Pub. No.: US 2006/0285359 A1
(43) Pub. Date: Dec. 21, 2006

(54) Light guide plate having high utilization of light energy and backlight module adopting the same

(75) Inventors: Xing-Peng Yang, Beijing (CN); Ying-Bai Yan, Beijing (CN); Guo-Fan Jin, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 11/454,489

(22) Filed: Jun. 16, 2006

(30) Foreign Application Priority Data
Jun. 17, 2005 (CN) 200510035405.X

(51) Int. Cl. F21V 7/04

(52) U.S. Cl. 362/615

(57) ABSTRACT

A light guide plate includes an incident surface, an emission surface, and a bottom surface. The emission surface intersects with the incident surface and is substantially perpendicular to the incident surface. The bottom surface intersects with the incident surface and is opposite to the emission surface. The light guide plate is birefringent and has internal stresses/strains therein, causing the light guide plate to exhibit a light-polarizing phase delay. An angle between a direction of one of the main stresses/strains and the light incident surface is bigger than 0 degree and smaller than 90 degrees. A plurality of sub-wavelength gratings can be further formed on the emission surface of the light guide plate. A backlight module, adopting the above-mentioned light guide plate, further includes a corresponding light source positioned beside the incident surface of the light guide plate.

### CROSS-REFERENCE TO RELATED APPLICATIONS

This application is related to commonly-assigned corresponding applications entitled, “LIGHT GUIDE PLATE AND BACKLIGHT MODULE THEREWITH”, filed **** (Atty. Docket No. US8490) and “LIGHT GUIDE DEVICE AND BACKLIGHT MODULE THEREWITH”, filed **** (Atty. Docket No. US8491). The disclosure of the above-identified applications are incorporated herein by reference.

### BACKGROUND

1. Field of the Invention

The invention relates generally to light guide plates used in backlight modules of liquid crystal display devices and, more particularly, to a light guide plate having high utilization of light energy and a backlight module adopting the same.

2. Discussion of Related Art

Liquid crystal display devices have many excellent performance characteristics, such as large-scale information display ability, easily colored, low power consumption, long life, no pollution associated therewith, and so on. Therefore, liquid crystal display devices are used widely. A typical liquid crystal display device generally includes a backlight module, and the backlight module is used to convert linear light sources, such as cold cathode ray tubes, or point light sources, such as light emitting diodes, into area light sources having high uniformity and brightness.

Referring to FIG. 6, a typical liquid crystal display device 100 generally includes a display panel 10 and a backlight module 20 positioned below the display panel 10. The display panel 10 is sandwiched between a lower polarizer plate 12 and an upper polarizer plate 14. The backlight module generally includes a light source 202, a reflective plate 22, a light guide plate 24, a diffusion plate 26, and a prism sheet 28. The light source 202 is positioned beside the light guide plate 24. The reflective plate 22 is positioned below the light guide plate 24, and the diffusion plate 26 and the prism sheet 28 are positioned upon the light guide plate 24, in turn.

In use, incident light beams are emitted from the light source 202 and are transmitted into the light guide plate 24. The light guide plate 24 is used to direct travel of the incident light beams therein and ensures that most of the incident light beams can be emitted from a top surface of the light guide plate 24. The diffusion plate 26 is used to improve the uniformity of the light beams emitted from (i.e., transmitted out of) the light guide plate 24. The prism sheet 28 can converge the emitted light beams to the lower polarizer plate 12 (the emitted light beams converged to the lower polarizer plate 12 are labeled as T, for “transmitted”). This convergence helps ensure that the emitted light beams have good uniformity and brightness. The reflective plate 22 is used to reflect some of the incident light beams that are emitted from a bottom surface of the light guide plate 24 and back into the light guide plate 24. This reflection enhances the utilization ratio of the incident light beams from light source 202 (i.e., the degree to which the strength of the light beams emitted from light source 202 is able to be maintained through the device).

As shown in FIG. 6, each emitted light beam T includes both p-polarization light and s-polarization light. An amplitude of the s-polarization light is substantially the same as that of the p-polarization light, and a vector of the s-polarization light is substantially perpendicular to that of the p-polarization light. A polarization direction of the p-polarization light is substantially parallel to that of the lower polarizer plate 12, and a polarization direction of the s-polarization light is substantially perpendicular to that of the lower polarizer plate 12. Thus, the p-polarization light can be transmitted through the lower polarizer plate 12, but the s-polarization light can not be transmitted therethrough and is absorbed by the lower polarizer plate 12. Because about half of the emitted light beams T are absorbed by the lower polarizer plate 12, this absorbability reduces the utilization of light energy.

Referring to FIG. 7, another typical liquid crystal display device 300 generally includes a display panel 30 and a backlight module 40 positioned below the display panel 30. The display panel 30 is sandwiched between a lower polarizer plate 32 and an upper polarizer plate 34. The backlight module generally includes a light source 402, a reflective plate 42, a light guide plate 44, a diffusion plate 46, a prism sheet 48, a polarizing beam splitter (PBS) 406, and a quarter-wave plate 404. The light source 402 is positioned beside the light guide plate 44. The reflective plate 42 is positioned below the light guide plate 44, and the quarter-wave plate 404 is sandwiched between the reflective plate 42 and the light guide plate 44. The diffusion plate 46 and the prism sheet 48 are positioned upon the light guide plate 24, in turn, and the PBS 406 is located between the lower polarizer plate 32 and the prism sheet 48.

In use, incident light beams are emitted from the light source 402 and are transmitted into the light guide plate 44. The light guide plate 44 is used to direct travel of the incident light beams therein and ensures that most of the incident light beams can be emitted from a top surface of the light guide plate 24. The diffusion plate 46 is used to improve the uniformity of the light beams emitted from (i.e., transmitted out of) the light guide plate 44. The prism sheet 48 can converge the emitted light beams to the PBS 406 (the emitted light beams converged to the PBS 406 are labeled as T). This convergence helps ensure that the emitted light beams have good uniformity and brightness. The reflective plate 42 is used to reflect some of the incident light beams that are emitted from a bottom surface of the light guide plate 44 and back into the light guide plate 44. This reflection enhances the utilization ratio of the incident light beams from light source 402 (i.e., the degree to which the strength of the light beams emitted from light source 402 is able to be maintained through the device).

As shown in FIG. 7, each emitted light beam T includes both p-polarization light and s-polarization light. An amplitude of the s-polarization light is substantially as same as that of the p-polarization light, and a vector of the s-polarization light is substantially perpendicular to that of the p-polarization light. A polarization direction of the p-polarization light is substantially parallel to that of the PBS 406, and a polarization direction of the s-polarization light is substantially perpendicular to that of the PBS 406. Thus, the p-polarization light can be transmitted through the PBS 406 and the lower polarizer plate 32, but the s-polarization light can not be transmitted therethrough and is reflected into the backlight module 40 by the PBS 406. The s-polarization light is transmitted through the prism sheet 48, the diffusion plate 46, the light guide plate 44 and the quarter-wave plate 404 in turn, and is transmitted to the reflective plate 42. Then, the s-polarization light is reflected by the reflective plate 42 and is transmitted through the quarter-wave plate 404. The quarter-wave plate 404 can convert the s-polarization light into p1-polarization light and s1-polarization light (not shown) with a relatively small intensity. A polarization direction of the p1-polarization light is as same as that of the p-polarization light. Thus, the p1-polarization light can be transmitted through the PBS 406 and the lower polarizer plate 32. Therefore, the backlight module 40 can enhance the utilization of light energy (theoretically, the brightness of the backlight module 40 is about double of that of the backlight module 20 ).

However, the s-polarization light must be transmitted from the light guide plate 44 before being converting into p1-polarization light by the quarter-wave plate 404. Reflective and refractive loss of the s-polarization light would expectedly be produced at an interface between the light guide plate 44 and the quarter-wave plate 404. This is disadvantageous to the enhancement of the utilization of light energy.

What is needed, therefore, is a light guide plate having a high utilization of light energy.

What is also needed is a backlight module adopting the above-described light guide plate.

### SUMMARY

In one embodiment, a light guide plate includes an incident surface, an emission surface, and a bottom surface. The emission surface intersects with the incident surface and is substantially perpendicular to the incident surface. The bottom surface intersects with the incident surface and is opposite to the emission surface. The light guide plate is birefringent and has stresses/strains therein, causing the light guide plate to exhibit a light-polarizing phase delay. An angle between a direction of one of the main stresses/strains and the light incident surface is greater than 0 degree and smaller than 90 degrees. A plurality of sub-wavelength gratings can be further formed on the emission surface of the light guide plate.

In another embodiment, a backlight module adopts the above-described light guide plate and further includes a light source. The light source is positioned beside the incident surface of the light guide plate.

Other advantages and novel features of the present light guide plate and the backlight module adopting the same will become more apparent from the following detailed description of preferred embodiments when taken in conjunction with the accompanying drawings.

### BRIEF DESCRIPTION OF THE DRAWINGS

Many aspects of the present light guide plate and the backlight module adopting the same can be better understood with reference to the following drawings. The components in the drawings are not necessarily to scale, the emphasis instead being placed upon clearly illustrating the principles of the present light guide plate and the backlight module adopting the same.

FIG. 1 is an isometric view of a light guide plate in accordance with a first embodiment of the present device;

FIG. 2 is a schematic, side view of FIG. 1, showing paths of light beams transmitted therein;

FIG. 3 is a schematic, side view of a backlight module adopting the light guide plate of FIG. 1;

FIG. 4 is an isometric view of a light guide plate in accordance with a second embodiment of the present device;

FIG. 5 is a schematic, side view of a backlight module adopting the light guide plate of FIG. 4;

FIG. 6 is a schematic, side view of a first conventional liquid crystal display device adopting a first conventional backlight module; and

FIG. 7 is a schematic, side view of a second conventional liquid crystal display device adopting a second conventional backlight module

Corresponding reference characters indicate corresponding parts throughout the several views. The exemplifications set out herein illustrate at least one preferred embodiment of the present light guide plate and the backlight module adopting the same, in one form, and such exemplifications are not to be construed as limiting the scope of the invention in any manner.

### DETAILED DESCRIPTION OF PREFERRED EMBODIMENTS

Reference will now be made to the drawings to describe embodiments of the present light guide plate and the backlight module adopting the same, in detail.

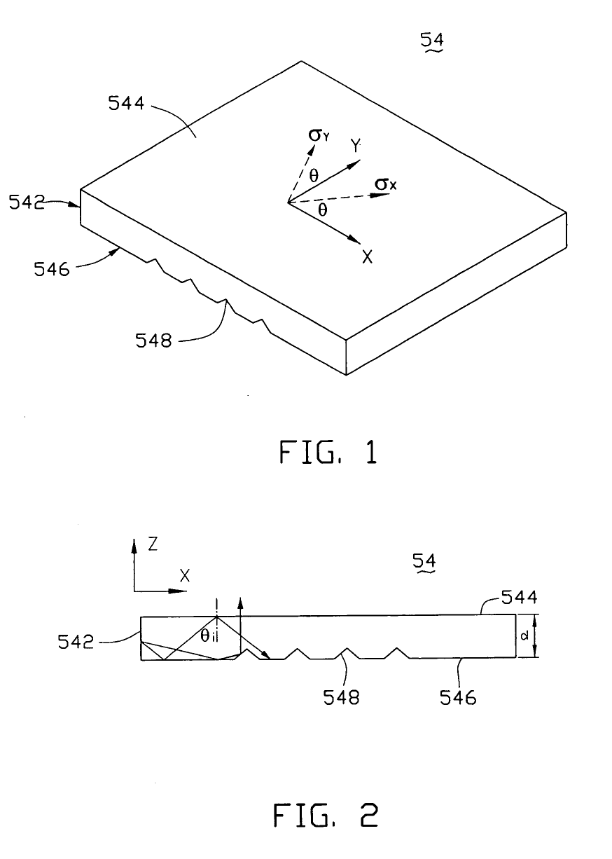

FIG. 1 is an isometric view of a light guide plate 54 in accordance with a first embodiment of the present device. As shown in FIG. 1, the light guide plate 54 includes an incident surface 542, an emission surface 544, and a bottom surface 546. The emission surface 544 intersects with the incident surface and is substantially perpendicular to the incident surface 542. The bottom surface 546 intersects with the incident surface and is opposite to the emission surface 544. Furthermore, a plurality of micro-structures 548 are formed on the bottom surface 546. The light guide plate 54 can be flat or wedged in shape. The light guide plate 54 can be, beneficially, made of polycarbon (PC), polymethyl methacrylate (PMMA), polyethylene, or glass. The micro-structures 548 are advantageously selected from the group consisting of V-shaped recesses, convex or concave columns, semi-spheres, pyramids, and pyramids without tips. The micro-structures 548 can be distributed on the bottom surface uniformly. Alternatively, a distribution density of the micro-structures 548 on the bottom surface 546 can be gradually larger along a direction proceeding away from the incident surface 542, and/or the micro-structures 548 can be gradually bigger along that direction. In the preferred embodiment, the light guide plate 54 is flat and is made of PC; the micro-structures 548 are V-shaped recesses; and the emission surface 546 is flat.

The light guide plate 54 is birefringent and has stresses/strains therein. The light guide plate 54 is made by using a photoelastic effect. The stresses/strains can be added into the light guide plate 54 during the molding process thereof. Then, the stresses/strains are kept in the light guide plate 54 by means of stress/strain freezing (i.e., cooling at high enough rate to avoid annealing/stress relief from taking place). As shown in FIG. 1, a direction perpendicular to the incident surface 542 is defined as the X-axis, a direction perpendicular to the X-axis and parallel to the emission surface 544 is defined as the Y-axis. Directions of the main stresses/strains σₓ, σ_{y}, are along broken lines, respectively and perpendicular to each other. An angle between the direction of the main stress σₓ and the X-axis is labeled as θ, and an angle between the direction of the main stress σ_{y} and the Y-axis is labeled as θ. This angular offset θ is the same relative to each axis, X and Y. A value of θ is in the range from 0 degree to 90 degrees. Preferably, the value of θ is 45 degrees.

The light guide plate 54 has a relatively large phase delay because of the stresses/strains therein. This phase delay ensures that the performance of the light guide plate 54 is similar to or as the same as that of a quarter-wave plate. Therefore, without additional quarter-wave plates, the light guide plate 54 alone can convert an s-polarization light into a p1-polarization light and s1-polarization light with a relatively small intensity. This internal ability to polarize light avoids interfacial reflective and refractive loss of the s-polarization light.

The followings is a demonstration of a conversion of the s-polarization light by the light guide plate 54. As shown in FIG. 2, assuming an incident light beam is in a plane defined by the X-axis and Z-axis, a direction of an electrical vector of a p-polarization light of the incident light is in the plane, a direction of an electrical vector of a s-polarization light of the incident light is along a normal of the plane, and a polarizing axis of a polarizing beam splitter is along the X-axis. A thickness of the light guide plate 54 is d. An incident angle is an angle between the incident light beam and a normal of the emission surface 544 and is labeled as θᵢ. The micro-structures 548 are configured for changing the incident angle θᵢ. The incident light beam can be emitted from the emission surface 522 when the incident angel θᵢ is relatively small. In order to simplify the demonstration, the incident angle θᵢ is assumed to be zero. That is, the incident angle θᵢ is along the normal of the emission surface 544.

The Jones vector Eᵢ of the s-polarization light is equal to

$$[ \begin{matrix}0 \\ 0\end{matrix} ] ( {E}_{i} = [ \begin{matrix}0 \\ 0\end{matrix} ] ) .$$

According to the Brewster law, a variable value of the refractive index is directly proportional to the main stresses, thus the following equality is given:
n_{σy}−n_{σx}=C(σ_{y}−σₓ) (1.1)
wherein n_{σx} and n_{σy} are the refractive indexes along the directions of the main stresses σₓ and σ_{y} respectively, and C is a constant. There is an optical path difference l produced after the incident light beam is transmitted through the light guide plate 54 with the thickness d. Therefore, the equality 1.1 can be changed as follows:
δ=2πCd(σ_{y}−σₓ)/λ (1.2)
A wavelength of the incident light beam is λ, thus the phase delay δ is as follows:
δ=2πCd(σ_{y}−σₓ)/λ (1.3)

The above-described equalities 1.2 and 1.3 are the stress-optical law of the photoelastic effect. The light guide plate 54 is converted into a phase delayer after the stresses are added. In the photoelastic effect examination, λ/C is generally defined as fσ, that is f_{σ}=λ/C. f_{σ}is the stress fringe value of the material of the light guide plate 54. Thus, the phase delay δ can be expressed as follows:
δ=2πd(σ_{y}−σₓ)/f_{σ} (1.4)

Therefore, the Jones matrix T_{δ} of the light guide plate 54 along the directions of the main stresses σₓ and σ_{y} can be expressed as follows:

$${T}_{δ} = [ \begin{matrix}1 & 0 \\ 0 & {ⅇ}^{jδ}\end{matrix} ] \qquad ( 1.5 )$$

The equality 1.5 is converted into the XY coordinate as follows:

$$T = R ( θ ) {T}_{d} R ( - θ ) = [ \begin{matrix}cos θ & - sin θ \\ sin θ & cos θ\end{matrix} ] [ \begin{matrix}1 & 0 \\ 0 & {ⅇ}^{jδ}\end{matrix} ] [ \begin{matrix}cos θ & sin θ \\ - sin θ & cos θ\end{matrix} ] \qquad ( 1.6 )$$

R(θ) in the equality 1.6 is the vector matrix of axis of coordinates. The following equality can be further concluded:

$$T = [ \begin{matrix}{cos}^{2} θ + {sin}^{2} {θⅇ}^{jδ} & sin θcosθ - sin θcos {θⅇ}^{jδ} \\ sin θcosθ - sin θcos {θⅇ}^{jδ} & {sin}^{2} θ + {cos}^{2} {θⅇ}^{jδ}\end{matrix} ] \qquad ( 1.7 )$$

The following equalities are given after the incident light beam is transmitted through the light guide plate 54 (i.e., phase delayer):

$$\begin{matrix}{E}_{0} = [ \begin{matrix}{E}_{ox} \\ {E}_{oy}\end{matrix} ] = {TE}_{i} = [ \begin{matrix}sin θcosθ - sin θcos {θⅇ}^{jδ} \\ {sin}^{2} θ + {cos}^{2} {θⅇ}^{jδ}\end{matrix} ] & ( 1.8 ) \\ {E}_{x} = Re [ {E}_{ox} ] = sin 2 θsin ( δ / 2 ) cos ( ω t + δ / 2 + π / 2 ) & ( 1.9 )\end{matrix}$$

Polarizing light intensity Iₓ is equal to sin²2 θ sin²(δ/2) (Iₓ=sin²2 θ sin²(δ/2)) after the incident light beam is transmitted through the polarizing beam splitter with the polarizing axis thereof along the X-axis. The equality 1.4 is brought into the equality of Iₓ, and Iₓ can be expressed as follows:
Iₓ=sin²2θsin²[πd(σ_{y}−σₓ)/f_{σ}]=sin²2θsin²(πdΔσ/f_{σ}) (1.10)
It is known that the value of Iₓ is biggest when the following condition is satisfied:

$$\{ \begin{matrix}2 θ = π / 2 \\ π d Δσ / {f}_{σ} = 2 kπ + π / 2\end{matrix} \qquad ( 1.11 )$$

Therefore, in order to get highest utilization of light energy, the angle θ between the direction of the main stress σₓ and the X-axis should be 45 degrees. It should be understood that even if the angle θ is in the range from 0 degree to 90 degrees and is not the optimal 45 degrees, some of the s-polarization light still can be reused/reclaimed.

Assuming the thickness d of the light guide plate 54 is 0.8 mm, the equivalent thickness of the light guide plate 54 is equal to 0.8*2 mm. In the preferred embodiment, the light guide plate 54 is made of PC, f_{σ} thereof is equal to 6.6 kN/m (f_{σ}=6.6 kN/m), and the following equality can be given:
Δσ=(2k+0.5)×4.125×10⁶N/m²_{k=0,1,2,3,4,. . .} (1.12)

Assuming phase delay δ is in the range from 0 degree to 360 degrees, the average polarizing light intensity Ĩ can be expressed as follows:

$${I}_{X}^{\%} = \frac{1}{2 π} {\int }_{0}^{2 π} \frac{1}{2} {sin}^{2} 2 θ ( 1 - cos δ ) ⅆ δ = \frac{{sin}^{2} 2 θ}{4} \qquad ( 1.13 )$$

Assuming the angle θ is equal to 45 degrees, the average polarizing light intensity Ĩ is equal to 0.25 (Ĩ=0.25). The polarizing light intensity from the polarizing beam splitter is equal to 1−(0.75)ⁿ after the s-polarization light is reflected in the light guide plate 54 for n times. The detailed data associated with this calculation is as follows:

TABLE ONE

| | n | | | | | | | | | |
|---|---|---|---|---|---|---|---|---|---|---|
| | 1 | 2 | 3 | 4 | 5 | 6 | 7 | 8 | 9 | 10 |
| I | 0.25 | 0.4375 | 0.578 | 0.684 | 0.763 | 0.822 | 0.867 | 0.900 | 0.925 | 0.944 |

From Table one, it is shown that 90% of the s-polarization light is converted into the p-polarization light after the s-polarization light is reflected for eight times.

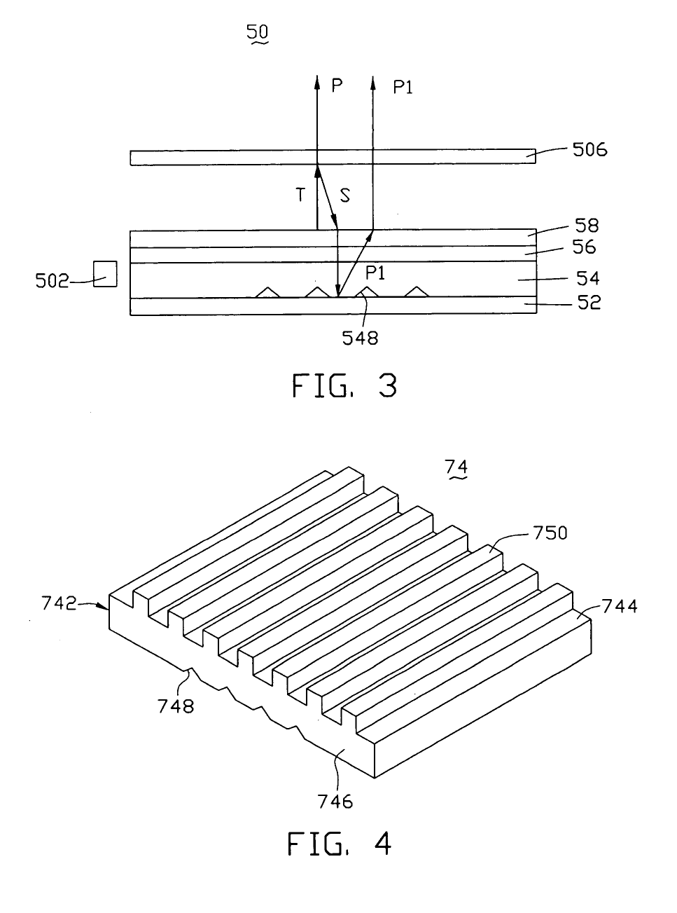

Referring to FIG. 3, a backlight module 50 adopting the above-described light guide plate 54 is shown. The backlight module 50 further includes a light source 502, a reflective plate 52, a diffusion plate 56, a prism sheet 58, and a reflective polarizing beam splitter (PBS) 506. The light source 502 is positioned beside the light guide plate 54. The reflective plate 52 is positioned below and adjacent the light guide plate 54. The diffusion plate 56 and the prism sheet 58 are positioned upon the light guide plate 54, in turn, and the PBS 506 is located upon the prism sheet 58. Alternatively, the PBS 506 can be disposed between the diffusion plate 56 and the emission surface 544 of the light guide plate 54 or between the diffusion plate 56 and the prism sheet 58. The light source 502 can be, e.g., light emitting diodes (LED) or cold cathode fluorescent lamps (CCFL). In the preferred embodiment, the light source 502 is a light emitting diode.

In use, incident light beams are emitted from the light source 502 and are transmitted into the light guide plate 54. The light guide plate 54 is used to direct travel of the incident light beams therein and ensures that most of the incident light beams can be emitted from a top surface of the light guide plate 54. The diffusion plate 56 is configured to improve the uniformity of the light beams emitted from (i.e., transmitted out of) the light guide plate 54. The prism sheet 58 can converge the emitted light beams to the reflective PBS 506 (the emitted light beams converged to the reflective PBS 506 is labeled as T, again for “transmitted”). This convergence helps ensure that the emitted light beams have good uniformity and brightness. The reflective plate 52 is used to reflect some of the incident light beams that are emitted from a bottom surface of the light guide plate 44 and back into the light guide plate 54. This reflection enhances the utilization ratio of the incident light beams from light source 502 (i.e., the degree to which the strength of the light beams emitted from light source 502 is able to be maintained through the device).

As shown in FIG. 3, each emitted light beam T includes both p-polarization light and s-polarization light. An amplitude of the s-polarization light is substantially the same as that of the p-polarization light, and a vector of the s-polarization light is substantially perpendicular to that of the p-polarization light. A polarization direction of the p-polarization light is substantially parallel to that of the reflective PBS 506, and a polarization direction of the s-polarization light is substantially perpendicular to that of the reflective PBS 506. Thus, the p-polarization light can be transmitted through the PBS 506 and provided to a display panel (not shown), but the s-polarization light can not be transmitted therethrough and is reflected into the backlight module 50 by the reflective PBS 506. The s-polarization light is transmitted through the prism sheet 58, the diffusion plate 56 and the light guide plate 54, in turn, and is transmitted to the reflective plate 52. Then, the s-polarization light is reflected by the reflective plate 52 and is transmitted through the light guide plate 54. Due to the phase delaying performance of the light guide plate 54, the s-polarization light is converted into p1-polarization light with a relatively small intensity. A polarization direction of the p1-polarization light is as same as that of the p-polarization light. Thus, the p1-polarization light can be transmitted through the PBS 506 and can be provided to the display panel. Therefore, the backlight module 50 can enhance the utilization of light energy (i.e., the brightness of the backlight module 50 is enhanced).

Referring to FIG. 4, a light guide plate 74 in accordance with a second embodiment of the present device is shown. As shown in FIG. 4, the light guide plate 74 includes an incident surface 742, an emission surface 744, and a bottom surface 746. The emission surface 744 intersects with the incident surface and is substantially perpendicular to the incident surface 742. The bottom surface 746 intersects with the incident surface and is opposite to the emission surface 744. Furthermore, a plurality of micro-structures 748 are formed on the bottom surface 746. The light guide plate 74 is birefringent and has stresses/strains therein. The light guide plate 74 is similar to the light guide plate 54, except that the light guide plate 74 further has a plurality of sub-wavelength gratings 750 formed on and, actually, integrally extending from the emission surface 744. A period of the sub-wavelength gratings 750 is one or more scale smaller than a wavelength of the incident light beam. The emission surface 744 with the sub-wavelength gratings 750 formed thereon can be used as a reflective PBS.

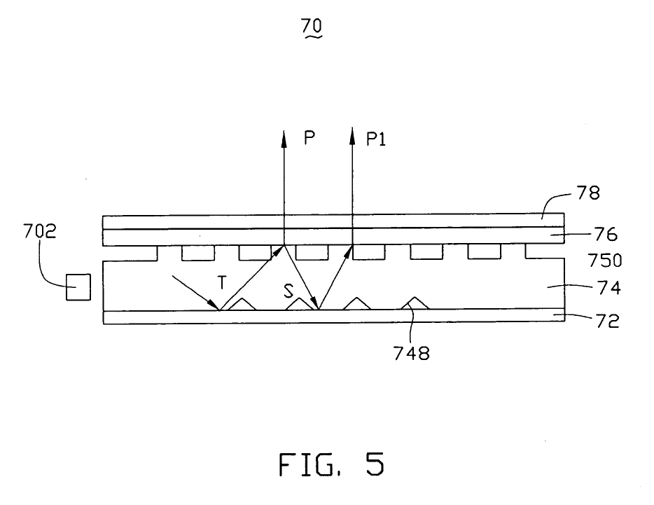

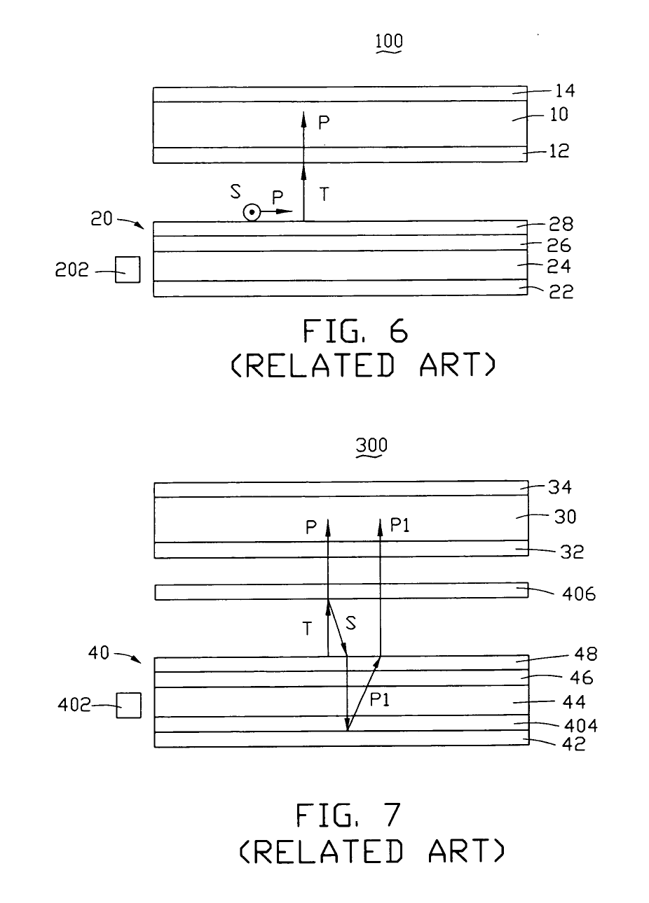

Referring to FIG. 5, a backlight module 70 adopting the above-described light guide plate 74 is shown. The backlight module 70 further includes a light source 702, a reflective plate 72, a diffusion plate 76, and a prism sheet 78. The light source 702 is positioned beside the light guide plate 74. The reflective plate 72 is positioned below the light guide plate 74. The diffusion plate 76 and the prism sheet 78 are positioned upon the light guide plate 74, in turn.

In use, incident light beams are emitted from the light source 702 and are transmitted into the light guide plate 74. The light guide plate 74 is used to direct travel of the incident light beams therein and ensure that most of the incident light beams can be emitted from a top surface of the light guide plate 74. The diffusion plate 76 is provided to improve the uniformity of the light beams emitted from (i.e., transmitted out of) the light guide plate 74. The prism sheet 78 can converge the emitted light beams to display panel (not shown). This convergence helps ensure that the emitted light beams have good uniformity and brightness. The reflective plate 72 is capable of reflecting at least some of the incident light beams that are emitted from a bottom surface of the light guide plate 74 and back into the light guide plate 74. This reflection enhances the utilization ratio of the incident light beams from light source 702 (i.e., the degree to which the strength of the light beams emitted from light source 702 is able to be maintained through the device).

As shown in FIG. 5, each incident light beam T includes both p-polarization light and s-polarization light. An amplitude of the s-polarization light is substantially as same as that of the p-polarization light, and a vector of the s-polarization light is substantially perpendicular to that of the p-polarization light. A polarization direction of the p-polarization light is substantially parallel to that of the sub-wavelength gratings 750, and a polarization direction of the s-polarization light is substantially perpendicular to that the sub-wavelength gratings 750. Thus, the p-polarization light can be transmitted through the sub-wavelength gratings 750 and further through the diffusion plate 76 and the prism sheet 78, but the s-polarization light can not be transmitted therethrough and is reflected into the light guide plate 74 by the sub-wavelength gratings 750. Due to the phase delaying performance of the light guide plate 74, the s-polarization light is converted into p1-polarization light with a relatively small intensity. A polarization direction of the p1-polarization light is the same as that of the p-polarization light. Thus, the p1-polarization light can be transmitted through the sub-wavelength gratings 750 and further through the diffusion plate 76 and the prism sheet 78. Therefore, the backlight module 70 can enhance the utilization of light energy (i.e., the brightness of the backlight module 70 is enhanced).

The light guide plates 54, 74 in accordance with the embodiments of the present device are birefringent and has stresses/strains therein. Thus, the backlight module 50, 70 adopting the light guide plate 54, 74 needn't employ additional quarter-wave plates and can reuse/reclaim the s-polarization light. This ability to internally reclaim the s-polarization light avoids interfacial reflective and refractive loss of the s-polarization light and, thus, is advantageous to enhance the utilization of light energy.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A light guide plate comprising:
an incident surface;
an emission surface intersecting with the incident surface and substantially perpendicular to the incident surface; and
a bottom surface intersecting with the incident surface and opposite to the emission surface;
wherein the light guide plate is birefringent and has internal stresses/strains therein, an angle between a direction of a main one of the stresses/strains and the incident surface is bigger than 0 degree and smaller than 90 degrees.

2. The light guide plate as claimed in claim 1, wherein the angle is about 45 degrees.

3. The light guide plate as claimed in claim 1, wherein a plurality of micro-structures is formed on the bottom surface.

4. The light guide plate as claimed in claim 3, wherein the micro-structures are selected from the group consisting of convex or concave columns, semi-spheres, pyramids, and pyramids without tips.

5. The light guide plate as claimed in claim 3, wherein the micro-structures are V-shaped recesses.

6. The light guide plate as claimed in claim 3, wherein the micro-structures are distributed on the bottom surface uniformly.

7. The light guide plate as claimed in claim 1, wherein the internal stresses/strains therein cause the light guide plate to exhibit a light-polarizing phase delay.

8. The light guide plate as claimed in claim 1, wherein the emission surface is flat.

9. The light guide plate as claimed in claim 1, wherein a plurality of sub-wavelength gratings is formed on the emission surface.

10. The light guide plate as claimed in claim 1, wherein the light guide plate is flat or wedged.

11. A backlight module comprising:
a light guide plate comprising:
an incident surface;
an emission surface intersecting with the incident surface and substantially perpendicular to the incident surface; and
a bottom surface intersecting with the incident surface and opposite to the emission surface;
at least one light source located beside the incident surface of the light guide plate;
a reflective plate positioned below the light guide plate; and
a polarizing beam splitter positioned upon the light guide plate;
wherein the light guide plate is birefringent and has internal stresses/strains therein, an angle between a direction of a main one of the main stresses/strains and the incident surface is bigger than 0 degree and smaller than 90 degrees.

12. The backlight module as claimed in claim 11, wherein the angle is about 45 degrees.

13. The backlight module as claimed in claim 11, wherein a plurality of micro-structures is formed on the bottom surface.

14. The backlight module as claimed in claim 11, wherein the emission surface is flat and the polarizing beam splitter is positioned upon the emission surface.

15. The backlight module as claimed in claim 11, wherein the polarizing beam splitter is a plurality of sub-wavelength gratings extending from the emission surface.

16. The backlight module as claimed in claim 11, further comprising a diffusion plate and a prism sheet positioned upon the light guide plate in turn, the polarizing beam splitter located at least one of between the diffusion plate and the emission surface of the light guide plate, between the diffusion plate and the prism sheet, and upon the prism sheet.
